(19) United States
(12) Patent Application Publication
(10) Pub. No.: US 2025/0194593 A1
(43) Pub. Date: Jun. 19, 2025

(54) PESTICIDAL COMPOSITIONS COMPRISING PENTANAL AND USES THEREOF

(71) Applicant: MIGAL GALILEE RESEARCH INSTITUTE LTD., Kiryat Shmona (IL)

(72) Inventors: Martin GOLDWAY, Timrat (IL); Dan GAMRASNI, Shamir (IL)

(73) Assignee: MIGAL GALILEE RESEARCH INSTITUTE LTD., Kiryat Shmona (IL)

(21) Appl. No.: 18/846,377

(22) PCT Filed: Mar. 14, 2023
(86) PCT No.: PCT/IL2023/050270

§ 371 Date: Sep. 12, 2024

Related U.S. Application Data
(60) Provisional application No. 63/319,409, filed on Mar. 14, 2022.

(51) Int. Cl. A01N 35/02; A01N 25/10; A01N 25/12; A01N 25/18; A01N 25/26; A01P 3/00

(52) U.S. Cl. CPC A01N 35/02; A01N 25/10; A01N 25/12; A01N 25/18; A01N 25/26; A01P 3/00

(57) ABSTRACT

In one aspect of the invention, there is provided herein a pesticidal composition comprising pentanal and a solid carrier. Further provided are methods of application of the pesticidal composition, such as for prolonging shelf-life of the edible matter.

### CROSS-REFERENCE TO RELATED APPLICATIONS

This application claims the benefit of priority of U.S. Provisional Patent Application No. 63/319,409, titled “PESTICIDAL COMPOSITIONS COMPRISING PENTANAL AND USES THEREOF”, filed Mar. 14, 2022, the contents of which are incorporated herein by reference in their entirety.

### FIELD OF THE INVENTION

The invention relates generally to the field of compositions and methods for reducing pathogen load on a substrate.

### BACKGROUND OF THE INVENTION

Safe and reliable means of removing or preventing growth of microorganisms on or within an edible matter upon prolonged storage thereof is a growing public health and agricultural concern. Existing methods for removing or reducing pathogens (such as fungi) in storage facilities do not adequately control microorganisms that have the potential to cause disease or spoilage. Furthermore, most of current methods include implementation of high amounts of toxic pesticides.

Accordingly, there is a great need for new methods and compositions comprising compounds with significantly lower toxicity, for reducing the presence of microorganisms and/or for increasing storage shelf life of edible matter.

The foregoing examples of the related art and limitations related therewith are intended to be exemplary and illustrative, not limiting in scope. Other limitations of the related art will become apparent to those of skill in the art upon reading of the following detailed description and a study of the figures.

### SUMMARY OF THE INVENTION

The following embodiments and aspects thereof are described and illustrated in conjunction with compositions systems, tools and methods which are meant to be exemplary and illustrative, not limiting in scope.

In one aspect of the invention, there is provided a pesticidal composition comprising pentanal and a solid carrier, wherein a w/w ratio between the solid carrier and pentanal within the composition is up to 3:1.

In another aspect of the invention, there is provided a pesticidal composition comprising pentanal and a solid carrier, wherein a w/w ratio between the solid carrier and pentanal within the composition is up to about 1:2.

In one embodiment, the pesticidal composition is in a form of a free flowable powder.

In one embodiment, the pesticidal composition is packaged within a gas permeable container.

In one embodiment, the pesticidal composition further comprising a binder, and wherein the pesticidal composition is a compressed powder.

In one embodiment, the binder is cellulose or a cellulose derivative; and a w/w ratio between the sorbent and the binder is between about 1.5:1 and about 1:1.5.

In one embodiment, the compressed powder further comprising a lipid component, and optionally comprising a coating.

In one embodiment, the lipid component comprises a fatty acid, an oil, or both.

In one embodiment, a w/w ratio between the lipid component and the sorbent is between 1:10 and 1:2.

In one embodiment, the coating comprises a wax or a fat, and wherein the coating constitutes between 5 and 20% of the compressed powder.

In one embodiment, a w/w ratio between the solid carrier and pentanal is between 1:0.01 and 1:2.

In one embodiment, a weight ratio between the solid carrier and pentanal within the composition is between about 100:1 and about 1:2.

In one embodiment, the pesticidal composition is configured to release a pesticide effective amount of pentanal into the entire air of a container, and wherein the pesticide effective amount is between about 30 and about 100 ppm.

In one embodiment, the w/w ratio between the solid carrier and pentanal within the composition is up to 1:2.2.

In one embodiment, the w/w ratio between the solid carrier and pentanal within the composition is between 100:1 and 1:2.2.

In one embodiment, the w/w ratio between the solid carrier and pentanal within the composition is between 10:1 and 1:2.2.

In one embodiment, the w/w ratio between the solid carrier and pentanal within the composition is between 50:1 and 1:2.2.

In one embodiment, the w/w ratio between the solid carrier and pentanal within the composition is between 50:1 and 1:1.

In one embodiment, the w/w ratio between the solid carrier and pentanal within the composition is between about 50:1 and about 3:1.

In one embodiment, the solid carrier is or comprises a sorbent, and wherein pentanal is adsorbed on the sorbent.

In one embodiment, the sorbent is in a form of particulate matter characterized by a particle size of between 100 and 1000 um.

In one embodiment, the sorbent is characterized by a density of at least about 100 g/L.

In one embodiment, the sorbent comprises silica.

In one embodiment, the pesticidal composition is in a form of a free flowable powder.

In one embodiment, the pesticidal composition is packaged within a gas permeable container.

In one embodiment, the pesticidal composition further comprising a binder, and wherein the pesticidal composition is a compressed powder (e.g. in a form of a tablet, a pill, or a granule).

In one embodiment, a w/w ratio between the sorbent and the binder is between 3:1 and 1:3.

In one embodiment, the composition further comprises a lipid component, and optionally comprising a coating.

In one embodiment, the lipid component comprises a fatty acid, an oil, or any combination.

In one embodiment, a w/w ratio between the sorbent and the lipid component is between 1:10 and 2:1.

In one embodiment, the solid carrier is or comprises a wax, a fat or both.

In one embodiment, the pentanal is dispersed within the solid carrier.

In one embodiment, a w/w ratio between the solid carrier and pentanal is between 1:0.01 and 1:0.1, or between 1:0.01 and 1:1.

In one embodiment, the composition is in a form of a tablet or a granule.

In one embodiment, the wax or the fat is characterized by a melting point between 4° and 100° C.

In one embodiment, the wax comprises carnauba wax, candelilla wax, berry wax, sunflower wax, Myrica fruit wax, rice bran wax, lanolin and jojoba oil bees wax, paraffin wax, or any combination thereof.

In one embodiment, the fat comprises Caprylic acid, Capric acid, Lauric acid, Myristic acid, Palmitic acid, Stearic acid, Arachidic acid, Behenic acid, Lignoceric acid or Cerotic acid, including any ester, mono-, di-, tri-glyceride, a phospholipid, a salt or any combination thereof.

In one embodiment, the pesticidal composition is configured to release a pesticide effective amount of pentanal into the entire air of a container.

In another aspect, there is provided a method for controlling pathogen related decay of an edible matter, the method comprising providing a pesticide effective amount of the pesticidal composition of the invention in close proximity to the edible matter under appropriate conditions, thereby controlling pathogen related decay of the edible matter; wherein controlling is by at least 10% compared to a control.

In one embodiment, the close proximity comprises within a storage container, within a storage room or both.

In one embodiment, the pesticide effective amount is sufficient for releasing a pesticide effective amount of pentanal into the entire air of the storage container or of the storage room.

In one embodiment, the pesticide effective amount of pentanal is between 1 and 100 ppm.

The method of the invention, wherein the appropriate conditions comprise: (i) ambient atmosphere, and (ii) temperature of between 0 and 40° C.

In one embodiment, the pathogen comprises a fungi.

In one embodiment, the method is for controlling fungal loading on or within the edible matter.

In another aspect, there is provided an edible matter in contact with an antimicrobial composition comprising pentanal.

In one embodiment, the antimicrobial composition further comprises a surfactant.

In one embodiment, the edible matter is characterized (i) by prolonged shelf-life; (ii) by reduced pathogen load, or both (i) and (ii), relative to a control.

In addition to the exemplary aspects and embodiments described above, further aspects and embodiments will become apparent by study of the following detailed description.

### BRIEF DESCRIPTION OF THE FIGURES

FIGS. 1A-1C are images representing inhibition of various plant pathogens Alternaria alternata (1A), Botrytis cinerea (1B), and Penicillium expansum (1C) by pentanal vapors at a concentration of 18 ppm.

FIGS. 2A-2C are micrographs presenting the effect of pentanal vapors (lower panel) on the mycelium (2A), conidia (2B), and spores (2C) of Penicillium expansum, as compared to untreated counterparts (upper panel). White arrows represent damage of Penicillium expansum upon exposure to pentanal vapors.

FIGS. 3A-3B are bar graphs representing the development of rots (in mm) on pears that were inoculated with Penicillium expansum (3A) and Botrytis cinera (3B) spores. Pears were inoculated with different concentrations of Penicillium expansum spores: 10³ spores (A); 10⁴ spores (B); 10⁵ spores (C). The diameter of rots (in mm) was assessed after 2 months of cold storage (at 0° C.). The graphs represent untreated pears versus pears treated by pentanal vapors (18 ppm).

FIGS. 4A-4B are bar graphs representing antifungal activity of different VOCs. FIG. 4A represents the effect of Butyl acetate (B) Hexyl acetate (H), Isoamyl acetate (I), Trans-2-Hexanal (T), and Pentanal (P) and Control (C) at the concentrations of 1.8 μL/L or 18 μL/L on Penicillium expansum spores (CFU). Different letters represent significant differences between treatments (p<0.05). A-C-1.8 μL/L, a-c-18 μL/L 1.8. FIG. 4B represents the effect of different volatiles Hexyl acetate (H), Trans-2-Hexanal (T), Pentanal (P), Hexanal (He) and Control (C) at the concentrations of 0.9 μL/L, 1.8 μL/L or 18 μL/L on Penicillium expansum spores (CFU). Different letters represent significant differences between treatments (p<0.05). A-C-1.8 μL/L, a-c-18 μL/L 1.8.

FIG. 5 is a graph showing the release profile of pentanal from an exemplary compressed powder (tablet) and from a similar exemplary wax-coated tablet of the invention.

### DETAILED DESCRIPTION OF THE INVENTION

The present invention, in some embodiments thereof, is directed to compositions comprising an effective amount of pentanal. In some embodiments, the composition of the invention (also used herein as “the pesticidal composition”) comprises pentanal and a solid carrier. In some embodiments, the effective amount of pentanal is sufficient for releasing a pesticide or preservative effective amount effective amount of pentanal into the entire volume of a package, a container, or a storage room. In some embodiments, the pesticide or preservative effective amount of pentanal within the entire volume is between 1 and 100 ppm, or between about 30 and about 100 ppm.

The invention in one aspect thereof is based on a surprising finding that exposure of fruits to a pesticide or preservative effective amount of pentanal vapors, resulted in a significantly reduced pathogen (e.g. fungi) loading on or within the treated fruits, thus resulting in a prolonged storage period and shelf-life, as compared to untreated fruits stored at similar conditions.

Furthermore, the compositions of the invention in some embodiments thereof include solid tablets or granules and powderous compositions characterized by different release rate of pentanal therefrom. Accordingly, by utilizing the compositions disclosed herein it is possible to control the release rate of pentanal, so as to achieve a predefined pesticide effective amount of pentanal for a specific time period at a desired location.

The invention is further directed to a method for reducing or preventing pathogen load on or within an edible matter, comprising exposing the edible matter to an effective amount of the composition of the invention, thereby reducing or preventing pathogen load on or within the edible matter. In some embodiments, the method comprises exposing the edible matter to an effective amount of the composition of the invention sufficient for releasing a pesticide or preservative effective amount of pentanal vapors within the container (e.g. storage room). In some embodiments, the method is for preventing or reducing pathogen formation within a time period of between 5 days and 3 months or more (e.g. upon storage at room temperature). In some embodiments, the method is for preventing or reducing decay of the substrate (e.g. edible matter). In some embodiments, the decay is pathogen related decay. In some embodiments, preventing or reducing is by at least 10%, compared to a control (e.g. untreated composition).

### Composition

In one aspect of the invention, there is provided a composition comprising pentanal and a solid carrier, and wherein the composition is configured to release a pesticide effective amount of pentanal into the ambient within a specific location. In some embodiments, the ambient comprises the ambient atmosphere (e.g. air) at the specific location. In some embodiments, the ambient comprises the entire volume of the specific location selected from a storage room, a storage container, a package (e.g. a food package), or any entire lumen. In some embodiments, the ambient is in a fluid communication with an edible matter. In some embodiments, the specific location comprises an edible matter. As used herein, the terms “pesticide effective amount” and “preservative effective amount” are used herein interchangeably.

In some embodiments, the composition is a pesticidal composition. In some embodiments, the composition is a preservative composition. In some embodiments, the composition is a fungicidal composition. In some embodiments, the composition is an antimicrobial composition. In some embodiments, the composition is a bactericidal composition, and/or a fungicidal composition.

In some embodiments, the composition is configured to release a pesticide effective amount of pentanal under appropriate conditions suitable for (i) release of the pesticide effective amount of pentanal; and/or (ii) storage of an edible matter within the specific location. In some embodiments, the appropriate conditions comprise (i) a temperature between-5 and 40° C., between-5 and 0° C., between 0 and 20° C., between 0 and 30° C., between 20 and 40° C., including any range or value therebetween. In some embodiments, the pesticide effective amount of pentanal vapors is between about 10 and about 150 ppm, between about 20 and about 150 ppm, between about 30 and about 150 ppm, between about 30 and about 100 ppm, between about 25 and about 100 ppm, between about 25 and about 110 ppm, between about 30 and about 110 ppm, including any range between.

As used herein, the term “pesticide/pesticidal” or “preservative” is referred to a composition capable of reducing or controlling pathogen load on or within an edible matter, as compared to untreated edible matter. The term “reducing” or “controlling” is as described hereinbelow.

In some embodiments, the pathogen comprises a microorganism. In some embodiments, the pathogen is or comprises one or more plant pathogens. In some embodiments, the pathogen comprises a pest (e.g., an insect, mite, a nematode and/or a gastropod mollusk). In some embodiments, the pathogen comprises a fungus, a bacterium, or both. In some embodiments, the pathogen is pathogen associated with an edible matter. In some embodiments, the pathogen is a mold.

In some embodiments, the pesticidal composition of the invention is configured to prevent or reduce mold formation on or within the edible matter at appropriate storage conditions (i.e. for a time period and a temperature, as disclosed herein).

In some embodiments, the pesticidal composition of the invention when applied at an effective amount at to the storage container, is configured to prevent or reduce mold formation on or within the edible matter at appropriate storage conditions (i.e. for a time period and a temperature, as disclosed herein).

Non-limiting example of plant pathogens include but are not limited to: cryophiles, nematodes, mites, ticks, fungi, algae, mold, bacteria, viruses, spores, yeast, and bacteriophages or any combination thereof.

In some embodiments, the pathogen is selected from the group consisting of: bacteria, a fungus, a yeast, a virus, an algae, a mold, protozoa, an amoeba, and spore-propagating microorganisms or any combination thereof.

In some embodiments, bacteria are selected from the group consisting of gram-positive bacteria. In some embodiments, the gram-positive bacteria are selected from the group consisting of Staphylococcus, Streptococcus, Enterococcus, Bacillus, Corynebacterium, Nocardia, Clostridium, Actinobacteria and Listeria or any combination thereof.

In some embodiments, bacteria are selected from the group consisting of gram-negative bacteria. In some embodiments, the gram-negative bacteria are selected from the group consisting of Escherichia, Salmonella, Shigella, Enterobacteriaceae, Pseudomonas, Moraxella, Helicobacter, Stenotrophomonas, Bdellovibrio, acetic acid bacteria, Legionella, cyanobacteria, spirochaetes, green sulfur bacteria, green non-sulfur bacteria, and respiratory symptoms Moraxella or any combination thereof.

In some embodiments, bacteria are selected from the group consisting of Escherichia coli, Staphylococcus aureus, Pseudomonas aeruginosa and Enterococcus hirae or any combination thereof.

In some embodiments, the fungus is selected from the group consisting of Magnaporthe, Ophiostoma, Cryphonectria, Fusarium, Ustilago, Alternaria, Cochliobolus, Aspergillus, Candida, Cryptococcus, Histoplasma, and Pneumocytis or any combination thereof.

In some embodiments, the yeast is selected from the group consisting of Cryptococcus neoformans, Candida albicans, Candida tropicalis, Candida stellatoidea, Candida glabrata, Candida krusei, Candida parapsilosis, Candida guilliermondii, Candida viswanathii, Candida lusitaniae and Rhodotorula mucilaginosa or any combination thereof.

In some embodiments, the virus is selected from the group consisting of Adenoviruses, Herpesviruses, Poxviruses, Parvoviruses, Reoviruses, Picornaviruses, Togaviruses, Orthomyxoviruses, Rhabdoviruses, Retroviruses and Hepadnaviruses or any combination thereof.

In some embodiments, appropriate storage conditions comprise ambient atmosphere. In some embodiments, appropriate storage conditions comprise storage time of at least 1 d, at least 1 week, at least 1 month (m), at least 2 m, at least 3 m, at least 4 m, at least 5 m, at least 6 m, at least 7 m, at least 8 m, at least 10 m, at least 12 m, including any range or value therebetween. In some embodiments, the appropriate conditions comprise a gas pressure between 0.1 and 3 atm, including any range between, or an ambient pressure.

In some embodiments, a weight per weight (w/w) ratio between the solid carrier and pentanal within the composition is below 1:2, below 1:1, below 2:1, below 3:1, below 2.8:1, below 2.5:1, up to 3:1, up to 3.5:1, up to 4:1, up to 5:1, up to 7:1, up to 10:1, up to 20:1, up to 50:1, up to 100:1, up to 1000:1, including any range or value therebetween. In some embodiments, a weight per weight (w/w) ratio between the solid carrier and pentanal within the composition is about 3:1. A skilled artisan will appreciate that the above disclosed ratio is the maximum weight ratio, and the composition may contain any amount of pentanal lower than the maximum weight ratio, however, for the commercial use it is preferable to maximize the amount of pentanal within the composition.

In some embodiments, a w/w ratio between the solid carrier and pentanal within the composition is between 1000:1 and 3:1, between 1000:1 and 500:1, between 500:1 and 100:1, between 100:1 and 50:1, between 50:1 and 10:1, between 10:1 and 5:1, between 5:1 and 3:1, including any range or value therebetween. The exact ratio between pentanal and the solid carrier may vary, depending on the desired release rate and/or desired concentration of pentanal within the ambient of the specific location.

In some embodiments, pentanal is homogenously distributed within the solid carrier. In some embodiments, pentanal is encapsulated or embedded within the solid carrier. In some embodiments, pentanal is mixed with the solid carrier. In some embodiments, pentanal is adsorbed to the solid carrier.

In some embodiments, the composition of the invention comprises pentanal as the active ingredient. In some embodiments, the pesticide active ingredient of the composition consists essentially of pentanal. In some embodiments, the pesticide active ingredient of the composition is pentanal. In some embodiments, the composition of the invention is substantially devoid of an additional agriculturally active agent, besides pentanal. In some embodiments, the composition of the invention is substantially devoid of an additional pesticide.

In some embodiments, the composition of the invention is a solid. In some embodiments, the composition of the invention is solid at a temperature up to 40° C., up to 50° C., up to 60° C., up to 80° C., up to 100° C., or more including any range or value therebetween. In some embodiments, the composition of the invention is a solid under appropriate conditions.

In some embodiments, the solid carrier is a solid at a temperature up to 40° C., up to 50° C., up to 60° C., up to 80° C., up to 100° C., or more including any range or value therebetween.

### Powders

In some embodiments, the composition of the invention is a powderous composition.

In some embodiments, the powderous composition is in a form of a flowable powder. In some embodiments, the powderous composition is in a form of a free flowable powder. A skilled artisan will appreciate that flowable powders are well-known in the art. Furthermore, flowability of the powderous composition can be determined using commercially available instruments (such as powder flow tester, etc.).

In some embodiments, the powderous composition comprises a sorbent as the solid carrier, wherein pentanal is substantially adsorbed on the sorbent.

In some embodiments, a weight ratio between the sorbent and the pentanal within the powderous composition is below 1:3, below 1:2, below 1:2.2, below 1:1.5, below 1:1, below 1.5:1, below 2:1, below 3:1, below 2.8:1, below 2.5:1, up to 4:1, up to 5:1, up to 7:1, up to 10:1, up to 20:1, up to 50:1, up to 100:1, up to 1000:1, 1000:1 and 3:1, between 1000:1 and 500:1, between 500:1 and 100:1, between 100:1 and 50:1, between 50:1 and 10:1, between 10:1 and 5:1, between 5:1 and 3:1, between 1000:1 and 1:2, between 1000:1 and 1:1, between 1000:1 and 1:2.2, between 100:1 and 1:2, between 50:1 and 1:2, between 50:1 and 1:1, between 10:1 and 1:1, between 50:1 and 3:1, between 1000:1 and 3:1, between 100:1 and 3:1, between 50:1 and 2:1, between 10:1 and 2:1, between 10:1 and 3:1, including any range between. including any range or value therebetween. The exact ratio between pentanal and the sorbent may vary, depending on the desired release rate and/or desired concentration of pentanal within the ambient of the specific location.

In some embodiments, the sorbent is in a form of a particulate matter characterized by a particle size of between 50 and 1000 um, between 50 and 150 um, between 50 and 100 um, between 100 and 150 um, between 150 and 200 um, between 200 and 400 um, between 400 and 800 um, between 800 and 1000 um, including any range or value therebetween.

In some embodiments, the sorbent is substantially devoid of particles with a particle size up to 100 um, up to 80 um, up to 60 um, up to 50 um. In some embodiments, the sorbent is substantially devoid of particles with a particle size less than 50 um.

As used herein the term “particle size” refers to an averaged particle size within the composition. Furthermore, the term “particle size” refers to the largest distance between one side to the other side of a given particle. In a round or close to round particle (e.g. spherical or oblong particle) the size and the diameter are identical. In some embodiments, the term “particle size” refers to an average cross section size of the nanoparticles. The size of the particles may be evaluated using transmission electron microscopy (TEM) or scanning electron microscopy (SEM) imaging, or using dynamic light scattering (DLS) measurements.

In some embodiments, the term “average cross section size” may refer to the average of at least e.g., 80%, 90%, or 95% of the particles. In some embodiments, the term “average cross section size” refers to a number average of the plurality of nanoparticles. In some embodiments, the term “average cross section size” may refer to an average diameter of substantially spherical particles. In some embodiments, the terms “particle size” and “average cross section size” are used herein interchangeably.

In some embodiments, the sorbent is characterized by a density of at least about 100 g/L, at least about 150 g/L, at least about 200 g/L, at least about 250 g/L, at least about 300 g/L, at least about 500 g/L, including any range or value therebetween.

In some embodiments, the sorbent is characterized by a density greater than 50 g/L, greater than 100 g/L, greater than 150 g/L, including any range or value therebetween.

In some embodiments, the sorbent is characterized by a density between 100 and 500 g/L, between 100 and 200 g/L, between 200 and 300 g/L, between 200 and 500 g/L, between 150 and 500 g/L, between 150 and 300 g/L, between 150 and 200 g/L, between 200 and 280 g/L, between 300 and 500 g/L, including any range or value therebetween.

In some embodiments, the sorbent is a porous sorbent. In some embodiments, porous sorbent is characterized by a porosity and/or surface area sufficient for absorbing pentanal.

In some embodiments, the sorbent is characterized by a surface are of at least 50 m²/g, at least 80 m²/g, at least 100 m²/g, at least 120 m²/g, at least 150 m²/g, at least 180 m²/g, including any range or value therebetween.

In some embodiments, the sorbent is characterized by a porosity of between 50 and 92%, between 50 and 70%, between 70 and 90%, between 70 and 93%, between 70 and 95%, including any range or value therebetween.

In some embodiments, the sorbent comprises a single sorbent specie or a plurality of chemically distinct sorbent particles. In some embodiments, the sorbent comprises a ceramic particle (e.g. comprising an inorganic compound comprising a metal in an oxidized state, such as a metal salt). In some embodiments, the sorbent comprises clay particles. Non-limiting examples of clay include but are not limited to clay minerals comprising bentonite, sepiolite, palygorskite, attapulgite, smectite, montmorillonite, hectorite, kaolinite, halloysite, or vermiculite, including any range between.

In some embodiments, the sorbent comprises a metal oxide, or a metalloid oxide, such as SiO₂, TiO₂, Al₂O₃, Fe₂O₃, ZnO, and ZrO or any combination thereof. In some embodiments, the sorbent comprises a metal salt.

In some embodiments, the sorbent is or comprises silica. Various silica species are known in the art (e.g., SIPERNAT).

In some embodiments, the powderous composition of the invention comprises the sorbent and pentanal adsorbed thereto, wherein the sorbent comprises a particulate matter comprising clay particles or metal oxide particles (e.g. silica); and wherein a w/w ratio between the sorbent and pentanal within the powderous composition is between 1000:1 and 1:2, including any range between.

In some embodiments, the powderous composition of the invention consists essentially of the sorbent and pentanal adsorbed thereto, wherein the sorbent is a particulate matter comprising metal oxide particles (e.g. silica); and wherein a w/w ratio between the sorbent and pentanal within the powderous composition is between 100:1 and 1:2, including any range between.

In some embodiments, the powderous composition of the invention consists essentially of the sorbent and pentanal adsorbed thereto, wherein the sorbent is a particulate matter comprising metal oxide particles (e.g. silica); and wherein a w/w ratio between the sorbent and pentanal within the powderous composition is between 100:1 and 1:2, between 50:1 and 1:2, between 50:1 and 1:1, between 10:1 and 1:1, between 50:1 and 3:1, between 1000:1 and 3:1, between 100:1 and 3:1, between 50:1 and 2:1, between 10:1 and 2:1, between 10:1 and 3:1, including any range between.

In some embodiments, the powderous composition of the invention consists essentially of the sorbent and pentanal adsorbed thereto, wherein the sorbent is a particulate matter comprising metal oxide particles (e.g. silica); and wherein a w/w ratio between the sorbent and pentanal within the powderous composition is between 100:1 and 1:2, between 50:1 and 1:2, between 50:1 and 1:1, between 10:1 and 1:1, between 50:1 and 3:1, between 1000:1 and 3:1, between 100:1 and 3:1, between 50:1 and 2:1, between 10:1 and 2:1, between 10:1 and 3:1, including any range between; and wherein the sorbent and pentanal constitute between 80 and 99%, between 85 and 99%, between 80 and 99.9%, between 85 and 95%, between 90 and 99%, between 95 and 99%, between 95 and 97%, between 97 and 99% by dry weight of the composition.

In some embodiments, the powderous composition of the invention is characterized by fast release rate of pentanal. In some embodiments, the powderous composition of the invention is configured to release an effective amount of pentanal (e.g. a concentration of pentanal between 30 and 100 ppm) with a time period of between 5 minutes (min) and 1 hour, between 5 and 20 min, between 5 and 30 min, including any range between.

In some embodiments, fast release refers to the ability of the powderous composition of the invention to release about 50% of the initial pentanal content at an ambient pressure (about 1 atm) and a temperature of between 2° and 25° C. within a time period between 5 and about 10 min, or between 6 about 8 min.

In some embodiments, the powderous composition of the invention is packaged within a gas (e.g. pentanal vapors) permeable packaging or container (e.g. sachet). In some embodiments, the powderous composition of the invention is packaged of dispensed in a form of a unit dosage. The exact amount of the unit dosage may differ between the various compositions of the invention and depends on the volume of the storage container (e.g. entire air volume) to be treated by the powderous composition of the invention. For example, the unit dose of the powderous composition of the invention corresponds to about 0.5 g per 1 L of the ambient air volume in the storage container.

### Tablets

In some embodiments, the composition of the invention is in a form of a compressed powder. In some embodiments, the compressed powder is in a form of a pill, a table, or a granule. In some embodiments, the compressed powder may have any three-dimensional shape. In some embodiments, the compressed powder is devoid of uniform shape. In some embodiments, the compressed powder is devoid of a defined three-dimensional shape. In some embodiments, the compressed powder has at least one dimension (e.g. length, width, cross-section, height, etc.) of at least 1 mm.

In some embodiments, the compressed powder is shaped or dispensed in a form of unit doses. In some embodiments, the compressed powder (e.g. each unit dose) has at least one dimension between 1 mm and 1 m, between 1 and 10 mm, between 1 and 10 cm, between 1 and 100 cm, between 10 and 30 cm, between 30 and 50 cm, between 50 and 100 cm, including any range between. In some embodiments, the compressed powder (e.g. in a form of a tablet) has at least one dimension between 1 mm and 3 cm, and a weight between 0.1 and 1 g.

In some embodiments, the compressed powder of the invention comprises pentanal, the sorbent, and a binder. In some embodiments, the compressed powder of the invention comprises pentanal adsorbed to the sorbent.

In some embodiments, a w/w ratio between the sorbent and the pentanal within the compressed powder is below about 1:3, below about 1:2, below about 1:2.5, below about 1:2.2, below 1:1, below 2:1, below 3:1, below 2.8:1, below 2.5:1, up to 4:1, up to 5:1, up to 7:1, up to 10:1, up to 20:1, up to 50:1, up to 100:1, up to 1000:1, between 1000:1 and 1:1, between 1000:1 and 1:2, between 1000:1 and 1:3, between 10:1 and 1:1, between 10:1 and 1:2, between 1000:1 and 500:1, between 500:1 and 100:1, between 100:1 and 50:1, between 50:1 and 10:1, between 10:1 and 5:1, between 5:1 and 3:1, between 100:1 and 1:2, between 50:1 and 1:2, between 50:1 and 1:1, between 10:1 and 1:1, between 50:1 and 3:1, between 1000:1 and 3:1, between 100:1 and 3:1, between 50:1 and 2:1, between 10:1 and 2:1, between 10:1 and 3:1, including any range or value therebetween. The exact ratio between pentanal and the sorbent may vary, depending on the desired release rate and/or desired concentration of pentanal within the ambient of the specific location.

In some embodiments, a w/w ratio between the sorbent and the binder is between 5:1 and 1:5, between 5:1 and 3:1, between 3:1 and 2:1, between 2:1 and 1:1, between 1:1 and 1:5, between 1:1 and 1:2, between 1:2 and 1:5, including any range between. In some embodiments, a w/w ratio between the sorbent and the binder is between about 1.5:1 and 1:1.5, or about 1:1, including any range between.

In some embodiments, the binder comprises a polysaccharide. In some embodiments, the binder comprises a cellulose derivative. In some embodiments, the binder comprises a carboxylated polysaccharide. In some embodiments, the binder comprises a hydrophilic cellulose derivative. In some embodiments, the binder comprises hydroxy alkylated cellulose (e.g. hydroxyethyl cellulose, hydroxypropyl cellulose, hydroxypropyl methyl cellulose).

In some embodiments, the compressed powder of the invention comprises a lipid component. In some embodiments, a w/w ratio between the lipid component and the sorbent within the compressed powder is between 1:10 and 1:2, between 1:10 and 1:3, between 1:10 and 1:5, between 1:6 and 1:4, between 1:5 and 1:3, including any range between. In some embodiments, a w/w ratio between the lipid component and the sorbent is between about 1:5 and about 1:2, including any range between.

In some embodiments, the lipid component comprises a fat, an oil or both. In some embodiments, the lipid component comprises a fatty acid, including any salt and/or any ester thereof. In some embodiments, the lipid component comprises an unsaturated and/or a saturated fatty acid. In some embodiments, the lipid component comprises a plant oil. In some embodiments, the lipid component comprises a C10-C30 saturated (e.g. stearic acid) and/or unsaturated fatty acid.

In some embodiments, the lipid component comprises a first lipid component and a second lipid component, wherein the first lipid component comprises an oil (i.e. a liquid fat at room temperature of about 20-25 C); and the second lipid component comprises a fat (i.e. a solid at room temperature of about 20-25 C). In some embodiments, a w/w ratio between first lipid component and a second lipid component within the compressed powder is between 0.5:1 and 1:0.5, or about 1:1.

Non-limiting example of oils include but are not limited to cotton oil, peanut oil, canola oil, an olive oil, a sunflower oil, a safflower oil, a corn oil, a canola oil, a wheat germ oil, a peanut oil, a coconut oil, a vegetable oil, an orange oil, a citrus oil, a triglyceride oil, a terpenoid oil, a rapeseed oil, a soybean oil, a palm oil, a rice bran oil, or any combination thereof.

Non-limiting example of fats include but are not limited to lauric acid, myristic acid, palmitic acid, palmitate, palmitoleate, hydroxy palmitate, arachidic acid, oleic acid, stearic acid, sodium stearate, calcium stearate, magnesium stearate, hydroxy octadecanoyl hydroxy stearate, oleate esters of long-chain, esters of fatty acids, fatty alcohols, esterified fatty diols, hydroxylated fatty acid, hydrogenated fatty acid (saturated or partially saturated fatty acids), partially hydrogenated soybean, partially hydrogenated cottonseed oil, aliphatic alcohols, phospholipids, lecithin, phosphatidyl choline, triesters of fatty acids, hydrogenated coconut oil, cacao butter or any combination thereof.

In some embodiments, the compressed powder optionally comprises a coating. In some embodiments, the coating is gas permeable. In some embodiments, the coating comprises a polymer, a wax, a polysaccharide, or any combination thereof.

In some embodiments, the compressed powder of the invention is characterized by sustained release rate of pentanal (as compared to the powderous composition). In some embodiments, the compressed powder of the invention is configured to release an effective amount of pentanal (e.g. a concentration of pentanal between 30 and 100 ppm) with a time period of between 10 min and 30 min, between 10 and 20 min, between 10 and 25 min, between 15 and 20 min, between 10 and 40 min, including any range between.

In some embodiments, the compressed powder of the invention consists essentially of the sorbent and pentanal adsorbed thereto, binder and optionally the lipid component, wherein the sorbent is a particulate matter comprising metal oxide particles (e.g. silica); and wherein the sorbent and pentanal binder and optionally the lipid component constitute between 80 and 99%, between 85 and 99%, between 80 and 99.9%, between 85 and 95%, between 90 and 99%, between 95 and 99%, between 95 and 97%, between 97 and 99% by dry weight of the compressed powder.

In some embodiments, sustained release refers to the ability of the compressed powder of the invention to release about 50% of the initial pentanal content at an ambient pressure (about 1 atm) and a temperature of between 2° and 25° C. within a time period between about 10 and about 12 min, or between 15 about 20 min.

In some embodiments, sustained release refers to the ability of the compressed powder of the invention to release about 80% of the initial pentanal content at an ambient pressure (about 1 atm) and a temperature of between 2° and 25° C. within a time period between about 100 and about 150 min, or between 110 about 130 min.

### Wax-Coated Compositions

In some embodiments, the composition of the invention comprises a wax-coated compressed powder composition. In some embodiments, the wax coated compressed powder composition comprises the compressed powder of the invention as the solid carrier, wherein the compressed powder is at least partially (such as between 80 and 100%, between 90 and 100% between 95 and 99%, between 97 and 99% of the entire outer surface of the compressed powder is coated) coated or enclosed by a wax. In some embodiments, the composition of the invention comprises pentanal dispersed within the wax. In some embodiments, the wax-coated compressed powder composition is in a form of a pill, a table, or a granule.

In some embodiments, the wax is characterized by a melting point between 4° and 100° C., between 4° and 60° C., between 6° and 100° C., between 6° and 80° C., between 8° and 100° C., including any range between.

In some embodiments, a w/w ratio between the wax and pentanal is between 1:0.001 and 1:0.3, between 1:0.001 and 1:0.005, between 1:0.005 and 1:0.01, between 1:0.01 and 1:0.05, between 1:0.05 and 1:0.1, between 1:0.1 and 1:0.2, between 1:0.2 and 1:0.3, including any range between.

In some embodiments, the ratio between the wax and the sorbent is between 1:1 and 1:10, between 1:1 and 1:7, between 1:2 and 1:7, between 1:3 and 1:10, between 1:4 and 1:10, between 1:5 and 1:10, between 1:5 and 1:7, including any range in between.

In some embodiments, a weight portion of the wax within the wax-coated compressed powder composition is between 5 and 40%, between 5 and 30%, between 5 and 20%, between 5 and 10%, including any range between.

A skilled artisan will appreciate that the release rate is dependent on the coating thickness (predetermined by the weight portion of the wax), such that a thicker coating will prolong the release time of pentanal from the wax-coated compressed powder composition.

In some embodiments, any of the herein disclosed compositions of the invention is configured to release an effective amount of pentanal under appropriate conditions, wherein the effective amount and appropriate conditions are as described herein.

In some embodiments, the wax-coated compressed powder composition of the invention is characterized by a slow release rate of pentanal. In some embodiments, the wax-coated compressed powder composition of the invention is configured to release an effective amount of pentanal (e.g. a concentration of pentanal between 30 and 100 ppm) with a time period of between 0.5 and 5 h, or between 0.5 and 10 h, between 0.5 and 2 h, between 0.5 and 1 h, including any range between.

In some embodiments, slow release rate refers to the ability of the wax-coated compressed powder of the invention to release about 50% of the initial pentanal content at an ambient pressure (about 1 atm) and a temperature of between 2° and 25° C. within a time period between about 40 and about 100 min, or between about 40 about 60 min.

In some embodiments, sustained release refers to the ability of the compressed powder of the invention to release about 80% of the initial pentanal content at an ambient pressure (about 1 atm) and a temperature of between 2° and 25° C. within a time period between about 150 and about 300 min, or between 150 about 200 min.

In some embodiments, the wax-coated compressed powder composition of the invention is characterized by substantially lower pentanal release rate (e.g. at least 3 times, at least 5 times, at least 8 times, at least 10 times) as compared to the powderous composition comprising the same amount of pentanal.

In some embodiments, the wax-coated compressed powder composition of the invention is characterized by prolonged pentanal release (e.g. prolonged by at least 2 times, at least 3 times, at least 4 times, at least 5 times,) as compared to the non-coated compressed powder composition comprising the same amount of pentanal and being devoid of wax.

In some embodiments, the wax comprises a natural wax, a fat or both. In some embodiments, the natural wax comprises carnauba wax, candelilla wax, berry wax, sunflower wax, Myrica fruit wax, rice bran wax, lanolin and jojoba oil bees wax, paraffin wax, or any combination thereof.

In some embodiments, the fat comprises Stearic acid, Caprylic acid, Capric acid, Lauric acid, Myristic acid, Palmitic acid, Arachidic acid, Behenic acid, Lignoceric acid or Cerotic acid, including any ester, mono-, di-, tri-glyceride, a phospholipid, a salt or any combination thereof. In some embodiments, the fat comprises a long chain (e.g. C10-C30) saturated fatty acid.

Additional waxes and fats encompassed by the invention are well-known in the art.

In some embodiments, the pesticidal composition of the invention is packaged within a gas (e.g. pentanal vapors) permeable packaging or container (e.g. sachet). In some embodiments, the gas permeable container is configured to release pentanal vapors therefrom. In some embodiments, the pesticidal composition of the invention is packaged in a form of a unit dose, wherein each unit dose comprises an amount of the composition of the invention sufficient for releasing a pesticide effective amount of pentanal in a predetermined air volume.

The unit dosage may differ between the various compositions of the invention. For example, the unit dose of the powderous composition of the invention corresponds to about 0.5 g per 1 L of the ambient air volume in the storage container. In an additional example the unit dose of the compressed powder composition of the invention corresponds to about 0.2-0.3 g per 1 L of the ambient air volume in the storage container. A skilled artisan will appreciate that the exact dosage depends on the initial pentanal content in the composition. Thus, the dosage is so as to release the pesticide effective amount of pentanal (i.e. between about 30 and about 100 ppm) in the ambient air of the storage container.

In some embodiments, the wax-coated compressed powder of the invention consists essentially of the sorbent and pentanal adsorbed thereto, binder, wax and optionally the lipid component, wherein the sorbent is a particulate matter comprising metal oxide particles (e.g. silica); and wherein the sorbent and pentanal binder, wax and optionally the lipid component constitute between 80 and 99%, between 85 and 99%, between 80 and 99.9%, between 85 and 95%, between 90 and 99%, between 95 and 99%, between 95 and 97%, between 97 and 99% by dry weight of the wax-coated compressed powder.

In some embodiments, the pesticidal composition of the invention is substantially stable (e.g. substantially retains its physico-chemical properties and/or appearance) for a time period between 1 and 24 months or more. In some embodiments, the term “stable” refers to a storage stability of the composition, wherein storage stability comprises stability under appropriate storage conditions, as described herein.

In some embodiments, the pesticidal composition of the invention is further packed into a gas tight packaging or container. In some embodiments, the pesticidal composition within a gas tight packaging or container substantially retains its initial pentanal content for a time period between 1 and 24 months or more.

In another aspect of the invention, there is provided a liquid pesticidal composition (e.g. a coating composition) comprising pentanal and a surfactant. In some embodiments, the liquid composition comprises between 100 ppm and 50% w/w of pentanal and between 0.01 and 20% w/w of the surfactant. In some embodiments, the surfactant is selected from the group consisting of: a non-ionic surfactant, an anionic surfactant, a cationic surfactant and an amphoteric surfactant or any combination thereof.

Non-limiting examples of anionic surfactants include but are not limited to: (C6-C8) alkyl-sulfate and/or sulfonate (e.g., sodium or potassium lauryl sulfate, sodium or potassium dodecyl sulfate), fatty alcohol ether sulfate salt (e.g., (C12-C14)alkyl-O—(CH2CH2O)2-SO3-, ZOHARPON ETA 27), polyacrylate (e.g., sodium or potassium polyacrylates), or any combination thereof.

Non-limiting examples of non-ionic surfactants include but are not limited to: polysorbate (e.g. Tween 20, 40, 80, etc.), alkyl-polyglycoside (e.g., Triton CG 110, APG 810), polyethyleneglycol-(C11-C15)alkyl-ether (such as Imbentin AGS/35), alkoxylated fatty alcohol (such as Plurafac LF221), or any combination thereof.

In some embodiments, the composition of the invention further comprises an additive (e.g. anti-cacking agent, a moisture sorbent, etc.). In some embodiments, the additive comprises an organic additive (e.g., a scent or an odorant, a colorant, a pigment, an anti-freeze agent), an anti-foaming agent, an inorganic salt, an acid, a base, and a buffering agent or any combination thereof.

In some embodiments, a w/w concentration of the additive within the composition is from 0.1 to 10%, from 0.1 to 5%, from 0.1 to 3%, from 0.1 to 2%, from 0.1 to 1%, including any range therebetween.

In another aspect, the present invention provides a kit for combined preparations. In one embodiment, a “combined preparation” defines especially a “kit of parts” in the sense that the combination partners as described herein can be dosed independently or by use of different fixed combinations with distinguished amounts of the combination partners i.e., simultaneously, concurrently, separately or sequentially. In some embodiments, the parts of the kit of parts can then, e.g., be used simultaneously or chronologically staggered, that is at different time points and with equal or different time intervals for any part of the kit of parts. The ratio of the total amounts of the combination partners, in some embodiments, can be used in the combined preparation.

### Methods

In another aspect, there is a method for controlling pathogen related decay of an edible matter, the method comprising providing an effective amount of the composition of the invention in close proximity to the edible matter under appropriate conditions, thereby controlling pathogen related decay of the edible matter, and wherein an effective amount of the composition is sufficient for releasing a pesticide effective mount of pentanal vapors in to the ambient air. In some embodiments, the pathogen is as described hereinabove. In some embodiments, pesticide effective mount of pentanal vapors in the ambient air in close proximity to the edible matter is as disclosed hereinabove, e.g. between about 30 and about 100 ppm.

In some embodiments, close proximity comprises providing the composition to a specific location comprising the edible matter. In some embodiments, the specific location is selected from a container, package, a storage room, an area under cultivation or any combination thereof. In some embodiments, the specific location is in fluid (e.g. liquid or gaseous) communication with the edible matter.

In some embodiments, the specific location comprise at least one wall defining a lumen and configured to contain a gas volume. In some embodiments, the pesticide effective amount is sufficient is sufficient for releasing a pesticide effective amount of pentanal into the lumen (e.g. the entire volume of the specific location such as a package, a storage container or a storage room). In some embodiments, the pesticidal composition of the invention is configured to prevent or reduce mold formation on or within the edible matter at appropriate storage conditions (i.e. for a time period and a temperature, as disclosed herein). The term “container” encompasses any storage facility, such as storage room, or any container (e.g. a container having at least one opening, or a closed container).

In some embodiments, the method comprises exposing the edible matter to a pesticide effective concentration of pentanal (e.g. in the entire air of a specific location). In some embodiments, exposing is by providing the composition of the invention within the specific location. In some embodiments, the method comprises exposing the edible matter to a pesticide effective amount of the composition of the invention. In some embodiments, exposing is for a time period between 1 h and 12 months, between 1 h and 10 days, between 10 and 30 days, between 1 and 3 months, between 1 and 5 months, between 5 and 12 months, including any range between. In some embodiments, exposing is for the entire storage time of the edible matter.

In some embodiments, exposing comprises a single exposure to the pesticide affective amount of pentanal for a time period between 1 and 24 h, between 1 and 10 h, between 1 and 2 h, between 10 and 24 h, between 5 and 24 h, between 5 and 10 h, between 5 and 20 h, between 5 and 15 h, between 1 and 20 h, between land 15 h, between 1 and 5 h, including any rage between. In some embodiments, the single exposure is sufficient for preserving the edible matter for a time period ranging up to 20 days, up to 15 days, up to 10 days, up to 8 days, up to 7 days up to 6 days, up to 5 days, up to 4 days, up to 3 days, including any range between.

In some embodiments, the method comprises repeating the single exposure once, twice, etc. In some embodiments, the single exposure is repeated after a period of between 3 and 20 d, between 5 and 20 d, between 3 and 20 d, between 3 and 7 d, or after each 5-7 days, including any range between.

In some embodiments, exposing is under operable conditions comprising (i) a gas pressure between 0.1 and 3 atm, including any range between, or an ambient pressure, and (ii) a temperature between-5 and 40° C., between-5 and 0° C., between 0 and 20° C., between 0 and 30° C., between 2° and 40° C., including any range or value therebetween.

In some embodiments, pesticide effective amount of the composition of the invention comprises an amount sufficient for obtaining a pesticide effective concentration of pentanal in the entire gas volume within the specific location. In some embodiments, pesticide effective amount of the composition of the invention comprises an amount sufficient for obtaining a pesticide effective concentration of pentanal vapors of between about 30 and about 100 ppm within the ambient atmosphere at the specific location (e.g. entire gas volume of a container, a package, or a storage room). A skilled artisan will appreciate that the exact amount of the composition applied to a specific location may vary depending on the initial concertation of pentanal within the composition, pentanal release rate (predetermined by the chemical and physical properties of the composition, and by ambient pressure and temperature).

In some embodiments, pesticide effective amount of pentanal (e.g. pentanal vapors within the gas ambient air volume at a specific location) is between 30 and 100 ppm, between 1 and 10 ppm, between 10 and 20 ppm, between 15 and 20 ppm, between 20 and 30 ppm, between 10 and 30 ppm, between 25 and 130 ppm, between 25 and 110 ppm, between 10 and 50 ppm, between 50 and 100 ppm, between 50 and 70 ppm, between 70 and 100 ppm, including any range or value therebetween.

A skilled artisan will appreciate, that the exact value of the pesticide effective concentration of pentanal vapors may vary between different species of edible matter.

In some embodiments, providing or exposing is performed once. In some embodiments, providing or exposing is repeated one or more times. In some embodiments, providing or exposing is performed at one or more stages in a life-cycle of the edible matter (such as seeding, foliage, flowering, post-harvest, pre-harvest etc.). In some embodiments, the pesticidal composition is applied to a harvested fruit and/or vegetable. In some embodiments, the pesticidal composition is applied to a processed fruit and/or vegetable, wherein processed comprises any food processing technique, such as cooking, slicing, etc.

In some embodiments, the method is for (i) reducing edible matter decay; and/or (ii) reducing pathogen load of the edible matter. In some embodiments, the method is for controlling pathogen load (e.g. fungal load) on or within the edible matter.

In some embodiments, reducing is as compared to a non-treated edible matter. In some embodiments, controlling comprises reducing colony forming units (CFU) of the pathogen on or within the edible matter by a factor of at least 10,000, of at least 100,000, of at least 1,000,000, including any value or arrange therebetween, wherein reducing is as compared to a non-treated edible matter.

As used herein, the terms “controlling” and “reducing” are used interchangeably and are related to reduction of colony forming unit (CFU) on or within the edible matter, as compared to a non-treated edible matter, by a factor of between 2 and 10, between 10 and 100, between 100 and 1000, between 1000 and 10,000, between 10,000 and 100,000, between 100,000 and 1,000,000, including any range between.

In some embodiments, the method is for reducing pathogenic activity on or within the edible matter. As used herein, the term “reducing pathogenic activity” refers to the ability to inhibit, prevent, reduce or retard bacterial growth, fungal growth, biofilm formation or eradication of living bacterial cells, or their spores, or fungal cells or viruses in a suspension, on or within the edible matter, at the specific location, or any combination thereof. In some embodiments, inhibition or reduction or retardation of biofilm formation by a pathogen positively correlates with inhibition or reduction or retardation of growth of the pathogen and/or eradication of a portion or all of an existing population of pathogens.

In some embodiments, the method of the invention comprises reducing CFU/cm² on the surface of the edible matter by at least by a factor of 10, at least by a factor of 30, at least by a factor of 50, at least by a factor of 60, at least by a factor of 65, at least by a factor of 70, at least by a factor of 100, at least by a factor of 200, at least by a factor of 400, at least by a factor of 800, at least by a factor of 1000, at least by a factor of 10,000, at least by a factor of 100,000, at least by a factor of 1,000,000, as compared to a non-treated edible matter surface.

In some embodiments, the method of the invention comprises reducing CFU on or within the edible matter at least by a factor of 10, at least by a factor of 30, at least by a factor of 50, at least by a factor of 60, at least by a factor of 65, at least by a factor of 70, at least by a factor of 100, at least by a factor of 200, at least by a factor of 400, at least by a factor of 800, at least by a factor of 1000, at least by a factor of 10,000, at least by a factor of 100,000, at least by a factor of 1,000,000, as compared to a non-treated edible matter.

In some embodiments, the method of the invention comprises inhibiting or eradicating pathogen load on or within the edible matter, wherein inhibiting or eradicating comprise complete arrest of pathogen growth and/or complete eradication of the initial pathogen load.

Colonies start as single pathogen (CFU) which multiplies and forms a colony. Given enough CFUs close by, eventually, neighboring colonies will fuse. Increasing the magnification allows detection of micro-colonies before they fuse. In some embodiments, “colony” as used herein, refer to a colony observed by the naked eye.

In some embodiments, the method is for preventing pathogen infection of the edible matter at a storage temperature of below 30° C., below 25° C., below 20° C., below 10° C., below 5° C., during a time period of at least 1 month (m), at least 1 month (m), at least 2 m, at least 3 m, at least 4 m, at least 5 m, at least 6 m, at least 7 m, at least 8 m, at least 10 m, at least 12 m, including any range or value therebetween.

In some embodiments, the method is for prolonging shelf life of the edible matter, compared to the untreated edible matter. In some embodiments, prolonging is for a time period ranging from 1 to 100 days, from 1 to 10 days, from 1 to 60 days, from 10 to 20 days, from 20 to 40 days, from 40 to 60 days, from 60 to 100 days, including any range between.

In some embodiments, the method is for selectively reducing fungal activity on or within the edible matter, wherein reducing is as described hereinabove. In some embodiments, the method is for selectively reducing or preventing fungal activity.

In some embodiments, the method of the invention is for reducing edible matter decay. In some embodiments, edible matter decay comprises decay related to the pathogen load of the edible matter. In some embodiments, edible matter decay comprises decay related to common biological processes occurring within the harvested edible mater, such as dehydration, cell death, etc. As used herein, the term “reducing” comprises decay reduction of the edible matter treated by a sanitizing composition of the invention, as compared to a non-treated edible matter, wherein reduction is by a factor of between 2 and 10, between 10 and 100, between 100 and 1000, between 1000 and 10,000, including any range between.

In some embodiments, the method is for enhancing or prolonging storage stability and/or extending shelf life, relative to untreated edible matter. In some embodiments, enhancing or prolonging is by at least 20%, at least 50%, at least 100%, at least 200%, at least 500%, at least 1000%, including any range between.

In some embodiments, edible matter decay is selected from the group consisting of: loss from pathogen load, decomposing, sprouting, loss from a disease, rotting, dehydration, and blackheart formation, loss from a higher organism or any combination thereof.

In some embodiments, the edible matter is selected from the group consisting of fruits, vegetables, grains, sprouts, nuts, seeds, meats, meat products, milk, milk products, fish, poultry, eggs, and mixtures thereof. In some embodiments, the edible matter refers to a non-liquid (e.g. non-flowable) matter. In some embodiments, the edible matter is devoid of beverage.

Non-limiting example of edible matter include but are not limited to: apple, avocado, citrus (e.g. clementine, orange, grapefruit, lemon), date, kiwi, lychee, mango, peach, pear, persimmon, pomegranate, pepper, asparagus, banana, broccoli, cabbage, carrot, cauliflower, celery, corn, kohlrabi, cucumber, eggplant, garlic, lettuce, onion, peanut, potato, strawberry, sweet pepper, sweet potato, tomato, watermelon, grains (e.g. wheat, barley, etc.), dry fruits (almonds, nuts, etc.) and grape or any combination thereof.

In some embodiments, the edible matter treated by the method of the invention comprises trace amounts of pentanal (also referred to herein as an edible matter in contact with pentanal). In some embodiments, the term “trace amounts” any amount which is below the toxicity threshold of pentanal approved by a regulatory authority. In some embodiments, the term “trace amounts” encompasses any amount which is considered as safe for human consumption. In some embodiments, the term “trace amounts” encompasses any range between 0.1 ppm and 0.01% including any range or value between. The trace amounts of pentanal on or within the edible matter can be detected for example by GC, or GC-MS.

In some embodiments, the method comprises contacting or applying the edible matter with the liquid composition of the invention. In some embodiments, wherein contacting or applying is selected from spraying, submerging, dipping, coating, fogging, and injecting or any combination thereof.

In some embodiments, the method is for preventing biofilm formation on the edible matter. In some embodiments, the method is for inhibiting biofilm formation. In some embodiments, the method is for reducing existing biofilms. In some embodiments, the method is for breaking-down existing biofilms.

As used herein the term “biofilm” refers to any three-dimensional, matrix-encased microbial community displaying multicellular characteristics. Accordingly, as used herein, the term biofilm includes surface-associated biofilms. Biofilms may comprise a single microbial species or may be mixed species complexes, and may include bacteria, or other microorganisms.

In some embodiments, the biofilm is essentially nullified or is reduced by at least 20%, at least 30%, at least 40%, at least 50%, at least 60%, at least 70%, at least 80%, at least 90%, including any value therebetween.

### General

As used herein the term “about” refers to +10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

As used herein, the term “substantially” refers to at least 80%, at least 85%, at least 90%, at least 92%, at least 95%, at least 96%, at least 97%, at least 98%, at least 99%, including any range or value therebetween.

As used herein, the term “enhance” including any grammatical forms thereof, refers to least 10%, at least 20%, at least 30%, at least 40%, at least 50%, at least 60%, at least 70%, at least 100%, between 100 and 200%, between 200 and 300%, between 300 and 500%, between 500 and 1000%, between 1000 and 10000% including any range between, compared to a control.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

### Example 1

Exemplary powderous composition has been prepared as follows:

Pentanal was added to a solid sorbent (e.g. SIPERNAT 22 silica powder with average particle size: 120 um, surface area about 180 m²/g, density=245 g/l). The constituents were mixed while pressing (as is the motion used with a pestle and mortar), until a homogenic fine powder has been obtained. The exact amount of pentanal depends on the predetermined effective concentration of pentanal vapors in the storage container.

Based on numerous trials the inventors observed that the solid sorbent is capable of adsorbing up to about 200% pentanal by its initial dry weight.

Exemplary compressed powder composition (e.g. in a form of a tablet) has been prepared as follows:

Pentanal was added to a powder comprising about 40 w/w % silica (SIPERNAT 22), about 40 w/w % binder (e.g. hydroxyethyl cellulose); between 5 and 10% Canola Oil, and between 5 and 10% Stearic acid. Tablets were made by thoroughly mixing a predefined amount of pentanal (e.g. not more than about 0.4 g) with 0.5 g of the powder, and subsequently pressing the resulting mixture in a tablet press. The weight of each tablet was about 0.5 g. Exemplary tablet made as disclosed above, containing about 60-70 ul pentanal was sufficient for releasing of 100 ppm pentanal vapors in a 0.5 L container.

The inventors performed extensive experiments in order to find the optimum relationship between the pentanal and the solid carrier in the tablet. Based on the experimental data, it has been postulated that in order to obtain about 100 ppm of pentanal vapors in a 1 L container (under regular storage conditions including ambient pressure and a temperature between about 0 and 30° C.) the amount of pentanal to be added to the tablet should range between 120 and 140 ul (corresponding to between 96 and 141 mg).

The inventors found that various waxes can be implemented for the formation of wax-coated compressed powder composition (e.g. in a form of coated tablets). Beeswax was found as preferable, whereas Carnauba wax and Paraffin wax may be utilized for the preparation of wax-coated compressed powder composition. The preparation of the wax-coated tablet involves melting a predetermined amount of wax (about 6% by total weight of the resulting coated tablet) and coating the tablet (manufactured as disclosed above) by any suitable coating process (such as spray coating, melt-coating, fluid bed coating, etc.).

The inventors further calculated pentanal release rate into the ambient air from various compositions of the invention and compared the release rate to neat pentanal (liquid), as a negative control.

Table 1 presents the time period required for release of 50% of the initial pentanal amount.

TABLE 1

| Time (min) until | |
|---|---|
| 50% release | Composition |
| 5 | Pentanal (liquid) |
| 7.5 | Powderous composition |
| 17.5 | Compressed powder |
| 55 | Wax-coated compressed powder |

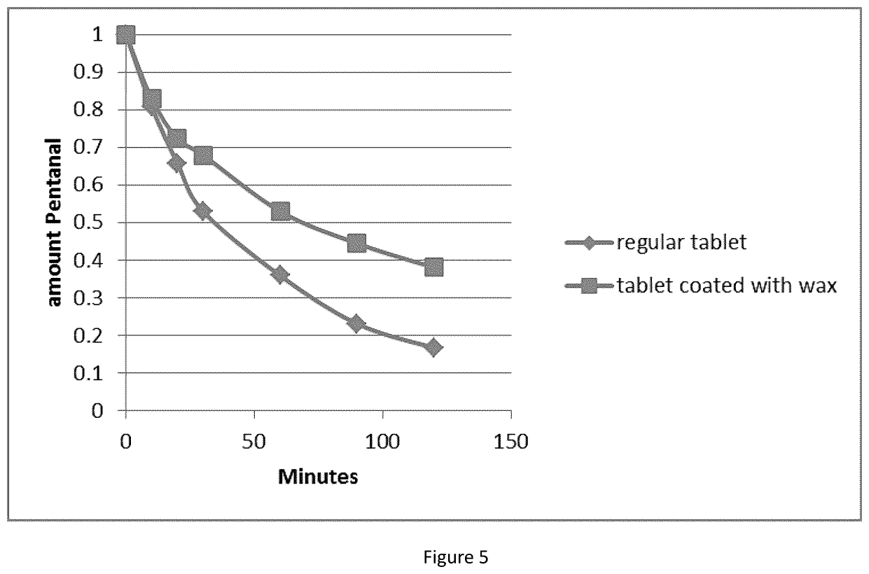

Exemplary release profile from the compressed powder tablet and wax-coated tablet is demonstrated in FIG. 5.

The inventors postulated that following parameters predetermine the release profile and release ratio of pentanal from the solid compositions of the invention:
Temperature: The higher the temperature, the faster the Pentanal is released.
Surface Area: The larger the surface area, the faster the release. For example, a powderous composition is characterized by a greater release rate compared to the same constituents in a form of a compressed powder (e.g. a tablet, or a granule).
Fixed Oils: The addition of non-volatile oils miscible with pentanal (such as cotton oil, canola oil, peanut oil, etc.) to the compressed powder composition, reduces the release rate of pentanal therefrom.

### Example 2

The inventors tested anti-fungal efficiency of pentanal vapors by exposing various fruits pathogens (e.g., Alternaria, Botrytis, and Penicillium species) to pentanal vapors at a concentration of about 18 ppm. Fruit (in vivo) or Petri dish with PDA (in vitro) inoculated with fungi spores (10³-10⁶ spores/ml) were exposed to pentanal vapors at concentrations of 10-100 ppm for 24 hr. after which the samples were aired and incubated until the pathogens developed in the untreated samples which served as control.

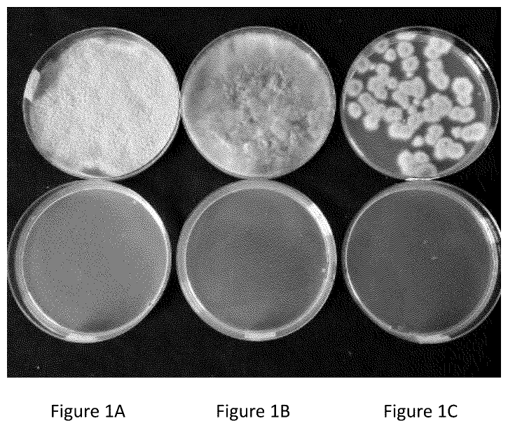

The results of this experiment are represented in FIG. 1. As demonstrated by FIG. 1, pentanal at a concentration of about 18 ppm completely prevented fungal growth in petri dish inoculated with spores of Penicillium expansum, Botrytis cinerea and Alternaria alternata while it was fully developed in the untreated plates (mycelium and spores).

Furthermore, various fruits (e.g. pears, strawberries and mandarins) have been exposed to between 10 and 30 ppm of pentanal (e.g. in a form of vapors, or by contacting thereof with an appropriate amount of any one of the composition of the invention). Upon exposure, the treated fruits have been stored for different time periods (in a cold room and/or at 20° C.). Subsequently, the decay of treated fruits has been examined and compared to untreated fruits. The results obtained by the inventors support the unexpected activity of pentanal at low ppm concentrations for prevention pathogen related decay (spoilage) thus significantly and prolonging the shelf-life of the treated fruits.

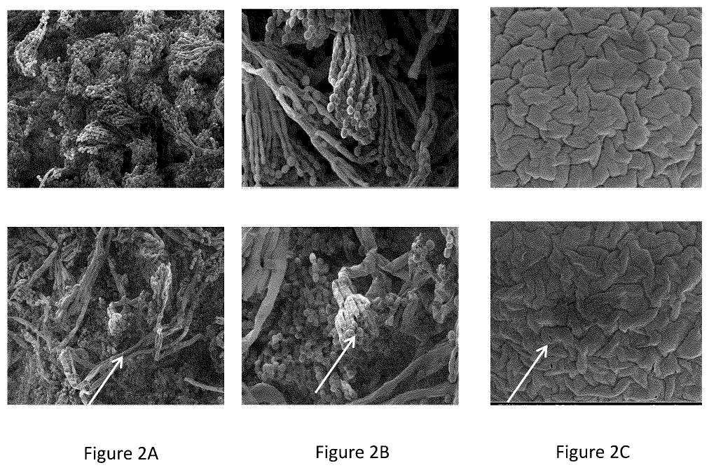

Mycelium and spores of Penicillium expansum treated and untreated with pentanal were analyzed using electronic microscope. Untreated mycelium and the spores of Penicillium expansum developed normally (FIG. 2, upper panel) while the Pentanal treated samples were impaired, the round structure of the mycelium was altered and along the mycelium damaged sites were observed (FIG. 2A). The conjugation sites of the spores in conidiophore were also damaged (FIG. 2B), and ruptures were visible on the spores' surface (FIG. 2C). These observations exhibit physical damage conferred by pentanal treated to Penicillium expansum.

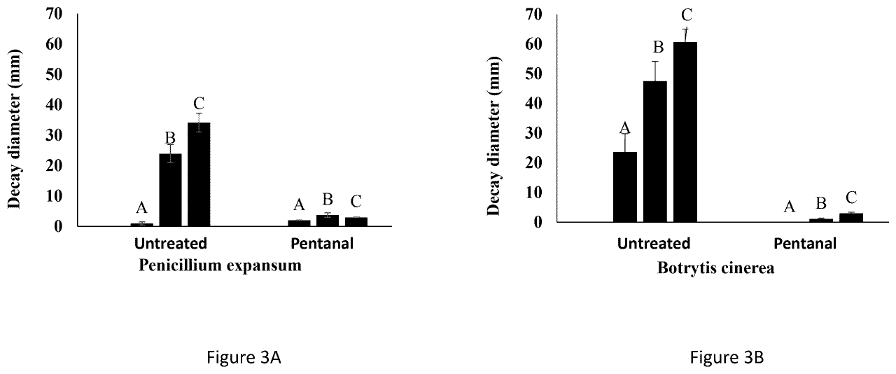

The results of an exemplary treatment (applied on pears that were inoculated with Penicillium expansum spores) are represented by FIGS. 3A-B. As shown in FIGS. 3A-3B, pentanal significantly delayed decay development in pears that were inoculated with different concentrations of Penicillium expansum and Botrytis cinerea spores. The decay was measured after 2 months of cold storage (0° C.).

Furthermore, the inventors tested the storage shelf-life of various inoculated fruit and vegetables species, such as: apples, pears, strawberries, lichi, cucumbers, citrus fruits, grapes under similar storage conditions upon exposure thereof to pentanal vapors. The fruits have been inoculated with Penicillium expansum and/or Botrytis cinerea spores and exposed to pentanal vapors at a concentration ranging between 30 and 100 ppm during the cold storage. The inventors observed that pentanal significantly prolong the shelf-life of all the tested fruits and vegetables, as compared to non-treated controls. The exact preservative effective amount of pentanal vapors varies dependent on the specific fruit specie, for example strawberries require higher concentration of pentanal, about 80-100 ppm. The inventors have found that the preservative effect amount of pentanal vapors required for efficient prolonging storage shelf-life of various fruit and vegetables species is between about 30 and about 100 ppm.

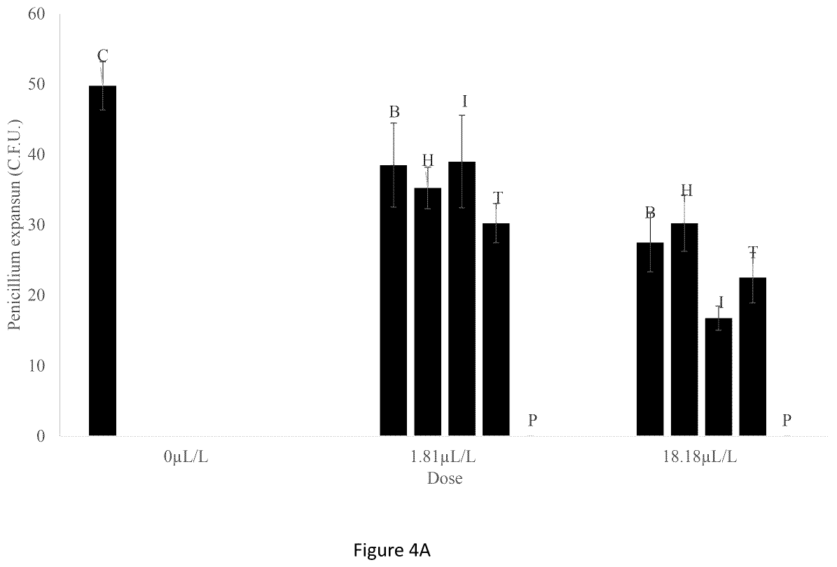

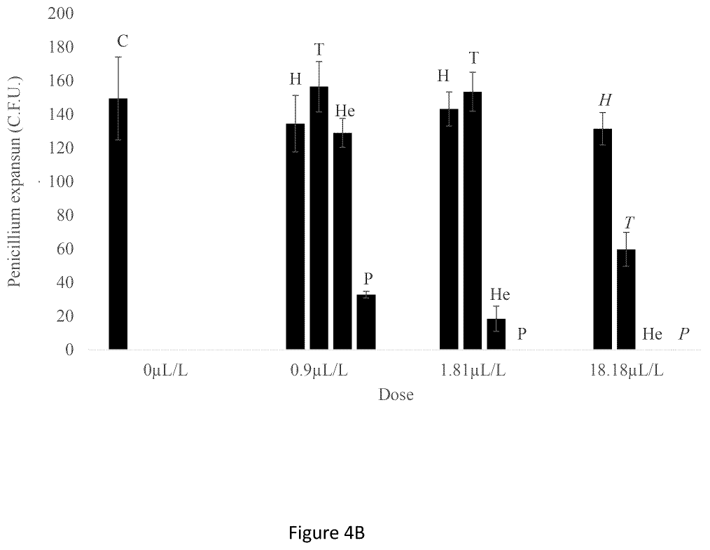

The inventors additionally examined the effect of different volatiles on the viability of Penicillium expansum spores. The volatiles tested were: Butyl acetate, Hexyl acetate, Isoamyl acetate, Trans-2-Hexane and they were compared to Pentanal at two different concentrations (1.8 μL/L or 18 μL/L). Furthermore, the inventors examined lower concentration (0.9 μL/L) for the following VOCs hexanal, trans-hexenal, and hexyl acetate on Penicillium expansum spores (CFU). As shown in FIG. 4, pentanal demonstrated significantly enhanced anti-fungal activity compared to other VOCs, at the tested concentrations. The results of these experiments are summarized in FIGS. 4A-4B.

The effect of incubation period (hours) of Penicillium expansum spores on PDA plates followed by exposure to pentanal vapors (1.8 ppm, or 18 ppm) for 24 hr was examined. 6 days after exposure no fungal colonies were detected on both plates (even after exposure to 1.8 ppm).

1. A pesticidal composition comprising pentanal and a solid carrier, wherein a w/w ratio between the solid carrier and pentanal within said pesticidal composition is up to about 1:2.

2. The pesticidal composition of claim 1, wherein said solid carrier is or comprises a sorbent, and wherein pentanal is adsorbed on the sorbent.

3. The pesticidal composition of claim 2, wherein said sorbent is in a form of particulate matter characterized by a particle size of between 100 and 1000 um.

4. The pesticidal composition of claim 2, wherein said sorbent is characterized by a density of at least about 100 g/L.

5. The pesticidal composition of claim 2, wherein said sorbent comprises silica.

6. The pesticidal composition of claim 2, wherein said pesticidal composition is in a form of a free flowable powder.

7. The pesticidal composition of claim 2, wherein said pesticidal composition is packaged within a gas permeable container.

8. The pesticidal composition of claim 2, further comprising a binder, and wherein the pesticidal composition is a compressed powder.

9. (canceled)

10. The pesticidal composition of claim 8, wherein the binder is cellulose or a cellulose derivative; and a w/w ratio between the sorbent and the binder is between about 1.5:1 and about 1:1.5.

11. The pesticidal composition of claim 8, further comprising a lipid component, and optionally comprising a coating optionally wherein the lipid component comprises a fatty acid, an oil, or both.

12. (canceled)

13. The pesticidal composition of claim 11, wherein a w/w ratio between the lipid component and the sorbent is between 1:10 and 1:2.

14. The pesticidal composition of claim 11, wherein said coating comprises a wax or a fat, and wherein said coating constitutes between 5 and 20% of said compressed powder.

15. The pesticidal composition of claim 8, wherein a w/w ratio between the solid carrier and pentanal is between 1:0.01 and 1:2.

16. (canceled)

17. The pesticidal composition of claim 14, wherein the wax or the fat is characterized by a melting point between 40 and 100° C., optionally wherein said wax comprises carnauba wax, candelilla wax, berry wax, sunflower wax, Myrica fruit wax, rice bran wax, lanolin and jojoba oil bees wax, paraffin wax, or any combination thereof; and wherein said fat comprises Caprylic acid, Capric acid, Lauric acid, Myristic acid, Palmitic acid, Stearic acid, Arachidic acid, Behenic acid, Lignoceric acid or Cerotic acid, including any ester, mono-glyceride, di-glyceride, tri-glyceride, a phospholipid, a salt, or any combination thereof.

18. (canceled)

19. The pesticidal composition of claim 1, wherein a weight ratio between the solid carrier and pentanal within said pesticidal composition is between about 100:1 and about 1:2.

20. The pesticidal composition of claim 1, wherein said pesticidal composition is configured to release a pesticide effective amount of pentanal into the entire air of a container, and wherein said pesticide effective amount is between about 30 and about 100 ppm.

21. A method for controlling pathogen related decay of an edible matter, the method comprising providing a pesticide effective amount of the pesticidal composition of claim 1 in close proximity to the edible matter under appropriate conditions, thereby controlling pathogen related decay of the edible matter; wherein controlling is by at least 10% compared to a control.

22. The method of claim 21, wherein said close proximity comprises within a storage container, within a storage room or both.

23. The method of claim 22, wherein any one of: (i) the pesticide effective amount is sufficient for releasing a pesticide effective amount of pentanal into the entire air of the storage container or of the storage room, optionally wherein the pesticide effective amount of pentanal is between 25 and 120 ppm; and (ii) said appropriate conditions comprise ambient atmosphere, and temperature of between 0 and 40° C.

24. (canceled)

25. (canceled)

26. The method of claim 21, wherein said pathogen comprises a fungi.

27. (canceled)

28. (canceled)

29. (canceled)

30. (canceled)
